(19) United States
(12) Patent Application Publication
(10) Pub. No.: US 2026/0320411 A1
(43) Pub. Date: Oct. 15, 2026

(54) CONFIDENTIALLY DISTRIBUTED MACHINE LEARNING

(71) Applicant: Robert Bosch GmbH, Stuttgart (DE)

(72) Inventors: Christian Zimmermann, Stuttgart (DE); Jared Weinfurtner, Bissingen An Der Teck (DE); Sebastian Becker, Ludwigsburg (DE); Sven Trieflinger, Renningen (DE)

(21) Appl. No.: 19/484,505

(22) PCT Filed: May 16, 2024
(86) PCT No.: PCT/EP2024/063486

§ 371 Date: Jan. 28, 2026

(30) Foreign Application Priority Data
May 24, 2023 (DE) 10 2023 204 817.5

(51) Int. Cl. G06N 3/098; H04L 9/00; H04L 9/32

(52) U.S. Cl. CPC G06N 3/098; H04L 9/008; H04L 9/3218

(57) ABSTRACT

A method comprising a computer-implemented method for a federated learning process for an owner of a machine learning model, a computer-implemented method for a federated learning process for an orchestrator, a computer-implemented method for a federated learning process for a training client, and a computer-implemented method for a federated learning process for an aggregator.

### BACKGROUND INFORMATION

Federated (machine) learning can be regarded as a subtype of distributed (machine) learning. In federated machine learning (see, e.g., Priyanka Mary Mammen, 2021, “Federated Learning: Opportunities and Challenges,” in Proceedings of ACM Conference (Conference'17), ACM, New York, NY, USA, 5 pages; arxiv.org/pdf/2101.05428.pdf), multiple devices, e.g., under the supervision of a central server, jointly learn a machine learning model, e.g., an artificial neural network, without sharing their private training data. Therefore, federated (machine) learning can be used in particular where private training data must not be shared for data protection reasons (e.g., in the health sector, financial sector, etc.).

In federated learning, local machine learning model updates are generated through local training procedures on the participating devices, which updates are aggregated (i.e., combined) into a trained global machine learning model. An algorithm for secure aggregation is described, e.g., in “SAFELearn: Secure Aggregation for private FEderated Learning,” Hossein Fereidooni et al., Cryptology ePrint Archive, Paper 2021/386; eprint.iacr.org/2021/386.

Trusted Execution Environments (TEE) provide a secure or trustworthy runtime environment for applications. A well-known example of a TEE is Intel Software Guard Extensions (Intel SGX), see, e.g., de.wikipedia.org/w/index php?title=Software_Guard_Extensions&old id=232528710. The concept of remote attestation is known in the context of trusted computing. This makes it possible, e.g., for modifications to a user's computer to be detected by authorized parties, see, e.g., en.wikipedia.org/w/index.php?title=Trusted_Computing&oldid=11515 65594#Remote_attestation.

In cryptography, a zero-knowledge proof is a method by which one party (the prover) can prove to another party (the verifier) that a given statement is true, while the prover avoids transmitting any additional information other than the fact that the statement is indeed true; see, e.g., en.wikipedia.org/w/index.php?title=Zero-knowledge_proof &oldid=1152088705.

(Secure) multi-party computation (MPC) (in German roughly: (sichere) Mehrparteienberechnung) is also a subfield of cryptography with the goal of developing methods with which parties can jointly compute a function over their input variables, wherein such input variables remain secret, see, e.g., en.wikipedia.org/w/index.php?title=Secure multi-party_computation&oldid=1148234769. Cloud-native (secure) multi-party computation can be implemented, e.g., using Carbyne Stack; see, e.g., carbynestack.io.

The present invention provides measures to improve confidentiality in federated learning.

### SUMMARY

A first general aspect of the present invention relates to a computer-implemented method for a federated learning process for an owner of a machine learning model. According to an example embodiment of the present invention, the method comprises generating a first secret(s) and a first signature (sig(s)) on the basis of a Schnorr non-interactive zero-knowledge proof (Schnorr NIZKP). The method further comprises sending the first signature (sig(s)) to an orchestrator. The method further comprises uploading a fourth secret share of the first secret (s) to a cluster of the aggregator, wherein a reference identifier (s_ref) for the first secret(s) on the cluster of the aggregator is obtained. The method further comprises providing a secure aggregation function (SecAgg(s_ref)) on the aggregator, which function is parameterized by the reference identifier (s_ref). The method further comprises starting a secret provisioning service that is designed to provide a network endpoint through which at least one training client can retrieve the first secret(s), subject to successful attestation. The method further comprises uploading a first secret share of a first multi-party computation (MPC) representation (CS(G_i)) of a machine learning model (G_i) to the cluster of the aggregator, wherein the owner is sent a first identifier (ID(CS(G_i)) ) for the first MPC representation (CS(G_i)) of the machine learning model (G_i) on the cluster of the aggregator. The method further comprises sending a first trigger signal comprising the first identifier (ID(CS(G_i)) ) to the orchestrator. Here, the secret provisioning service can be a specialized, secure service within a federated learning system, which service is designed to provide a protected mechanism for transmitting sensitive information, especially secrets (such as cryptographic keys or tokens), to authorized participants in the system. This can be carried out under strict security conditions, wherein the authenticity and authorization of the requesting participants (e.g., training clients) are checked by means of robust verification methods, such as remote attestation or zero-knowledge proofs. The orchestrator in a federated learning system can be a central control unit that is responsible for coordinating and managing the learning process across a distributed architecture of training clients. The orchestrator initiates, monitors and controls the various phases of the federated learning cycle, including the selection of training clients for learning iterations, the distribution of model updates and the collection and secure aggregation of local model updates. It ensures compliance with security and data protection guidelines by making sure that only authenticated and authorized participants can participate in the learning process. The orchestrator plays a key role in ensuring the efficiency and security of federated learning by coordinating the communication between the training clients and the aggregator, without having direct access to the private training data or the specific content of the model updates. The aggregator in a federated learning system can be a specialized component that is responsible for merging the local machine learning model updates provided by the training clients, in order to generate an updated global machine learning model. The aggregator uses secure and confidential methods, such as the secure aggregation function (SecAgg(s_ref)), which is parameterized by the reference identifier (s_ref) and refers to a shared secret.

A second general aspect of the present invention relates to a computer-implemented method for a federated learning process for an orchestrator. According to an example embodiment of the present invention, the method comprises generating a second secret(S) and a second signature (sig(S)) on the basis of a Schnorr non-interactive zero-knowledge proof (Schnorr NIZKP).

The method further comprises, for each training client (c_j) of a plurality (C) of training clients (c_j) for a training iteration, signing a random, training client-specific token (t_j) with the second secret(S) on the basis of Schnorr NIZKP, wherein a signed token (t_j_S) is obtained. The method further comprises, for each training client (c_j), sending the signed token (t_j_S) as a challenge to the particular training client (c_j). The method further comprises, for each training client (c_j), receiving a proof (p_j) from the particular training client (c_j). The method further comprises, for each training client (c_j), verifying the signed token (t_j_S), encoded in the proof (p_j), on the basis of the second signature (sig(S)), and, if successfully verified, verifying the proof (p_j) on the basis of the first signature (sig(s)). The method further comprises admitting those training clients (c_j) whose proof (p_j) has been successfully verified. The method further comprises sending a second trigger signal comprising a first identifier (ID(CS(G_i))) for a first MPC representation (CS(G_i)) of a machine learning model (G_i) on a cluster of an aggregator to each admitted training client (c_j) of the plurality (C) of training clients (c_j) for the training iteration if a first trigger signal comprising the first identifier (ID(CS(G_i))) has been received. The method further comprises sending a fourth trigger signal comprising a second identifier (ID(s j)) for a chained expression (s_j=(s, CS (L_i_j))) comprising a first secret(s) and a second MPC representation (CS(L_i_j)) of a local machine learning model update (L_i_j) on the cluster of the aggregator to the aggregator if at least a third trigger signal comprising the second identifier (ID(s j)) for the chained expression (s_j=(s, CS (L_i_j))) on the cluster of the aggregator has been received.

A third general aspect of the present invention relates to a computer-implemented method for a federated learning process for a training client (c_j). According to an example embodiment of the present invention, the method comprises retrieving a first secret(s) from a network endpoint of a secret provisioning service of an owner of a machine learning model if an attestation of the training client is successful. The method comprises receiving a signed token (t_j_S) as a challenge from an orchestrator. The method further comprises, if the first secret(s) could be retrieved, signing the signed token (t_j_S) with the first secret(s), wherein a proof (p_j=sign(s, t_j_S) is obtained. The method further comprises sending the proof (p_j) to the orchestrator. The method further comprises, if the training client (c_j) has been admitted by the orchestrator, downloading a first MPC representation (CS(G_i)) of a machine learning model (G_i) from a cluster of an aggregator on the basis of a first identifier (ID(CS(G_i))) if a second trigger signal comprising the first identifier (ID(CS(G_i))) has been received and the identity and authorization of the training client (c_j) on the cluster of the aggregator have been verified. The method further comprises converting the first MPC representation (CS(G_i)) of the machine learning model into a local machine learning model according to a predetermined MPC protocol. The method further comprises training the local machine learning model on the basis of local training data from the training client, wherein a local machine learning model update (L_i_j) is generated. The method further comprises converting the local machine learning model update (L_i_j) into a second MPC representation (CS(L_i_j)) according to the predetermined MPC protocol. The method further comprises generating a chained expression (s_j=(s, CS(L_i_j))) comprising the first secret(s) and the second MPC representation (CS(L_i_j)). The method further comprises uploading a second secret share of the chained expression (s_j) to the cluster of the aggregator, wherein a second identifier (ID(s_j)) for the chained expression (s_j) on the cluster of the aggregator is sent to the training client (c_j). The method further comprises sending a third trigger signal comprising the second identifier (ID(s_j)) to the orchestrator.

A fourth general aspect of the present invention relates to a computer-implemented method for a federated learning process for an aggregator. According to an example embodiment of the present invention, the method comprises sending a first identifier (ID(CS(G_i))) for a first MPC representation (CS(G_i)) of a machine learning model (G_i) on a cluster of the aggregator to an owner of the machine learning model (G_i) if a first secret share of the first MPC representation (CS(G_i)) is uploaded to the cluster of the aggregator. The method further comprises sending a second identifier (ID(s_j)) for a chained expression (s_j=(s, CS(L_i_j))) comprising a first secret(s) and a second MPC representation (CS(L_i_j)) of a local machine learning model update (L_i_j) on the cluster of the aggregator to a training client (c_j) if a second secret share of the chained expression (s_j=(s, CS(L_i_j))) is uploaded to the cluster of the aggregator. The method further comprises, if a fourth trigger signal comprising a second identifier (ID(s_j)) for a chained expression (s_j=(s, CS(L_i_j))) comprising a first secret(s) and a second MPC representation (CS(L_i_j)) of a local machine learning model update (L_i_j) on the cluster of the aggregator is received, executing a secure aggregation function (SecAgg(s_ref)) provided by the owner of the machine learning model (G_i), which function is parameterized by a reference identifier (s_ref), wherein, during execution, it is checked whether the chained expression (s_j=(s, CS(L_i_j))) comprises the secret according to the reference identifier (s_ref). The method further comprises, if the chained expression (s_j=(s, CS(L_i_j))) comprises the secret according to the reference identifier (s_ref), securely aggregating a local machine learning model update (L_i_j) with at least one further local machine learning model update on the basis of a predetermined MPC circuit, wherein a third secret share of a third MPC representation (CS(G (i+1))) for an aggregated machine learning model (G (i+1)) on a cluster of the aggregator along with a third identifier (ID(CS(G (i+1)))) for the third MPC representation (CS(G (i+1))) is obtained. The method further comprises sending the third identifier (ID(CS(G (i+1)))) to an orchestrator.

A fifth general aspect of the present invention relates to a method comprising the method according to the first general aspect of the present invention, the method according to the second general aspect of the present invention, the method according to the third general aspect of the present invention, and/or the method according to the fourth general aspect of the present invention.

A sixth general aspect of the present invention relates to a device that is designed to execute a method according to one of the above-described general aspects of the present invention.

A seventh general aspect of the present invention relates to a computer program that is designed to execute a method according to one of the above-described general aspects of the present invention.

An eighth general aspect of the present invention relates to a data carrier or signal that contains/encodes the computer program according to the seventh general aspect of the present invention.

In federated (machine) learning, a plurality, usually a large number, of devices, which are referred to below as training clients, jointly train a (global) machine learning model such as an (artificial) neural network. Here, the training clients do not have to be subject to the same responsibility. Instead, training clients can be located in different places and/or be subject to different responsibilities. An exemplary but not exclusive scenario comprises in each case one (local) training client per clinic, wherein each clinic has (local) training data (e.g., medical conditions, patient data, etc.) that it is not allowed to share with other clinics or entities, but is nevertheless willing to contribute to the training of the (global) machine learning model on the basis of its particular (local) training data. In general, this can be achieved by each (local) training client receiving a (global) machine learning model and generating a (local) machine learning model update on the basis of its (local) training data in that, e.g., the (global) machine learning model is trained In each case on a training client with the particular local training data. All (local) machine learning model updates are then aggregated by a central entity, which can be referred to as the aggregator, so that a (global) machine learning model update, and in particular a trained (global) machine learning model, is obtained.

Since the participating training clients keep their particular (local) training data to themselves and do not share them with third parties, federated learning is often seen as a more secure and more privacy-friendly approach for training machine learning models with sensitive data.

However, it has repeatedly been shown (see, e.g., Priyanka Mary Mammen, 2021, “Federated Learning: Opportunities and Challenges,” in Proceedings of ACM Conference (Conference'17), ACM, New York, NY, USA, 5 pages; arxiv.org/pdf/2101.05428.pdf and Benmalek et al., “Security of Federated Learning: Attacks, Defensive Mechanisms, and Challenges,” Revue des Sciences et Technologies de l'Information—Série RIA: Revue d'Intelligence Artificielle, 2022, 36 (1), pp. 49-59, 10.18280/ria.360106, hal-0362040, hal.science/hal-03620400/document) that conventional federated learning is far from being able to fully ensure the confidentiality of local training data. In particular, the training data can be derived by a malicious aggregator from machine learning model updates. Moreover, the global machine learning model may be vulnerable to inference attacks that aim to derive training data from output data of a (locally) trained machine learning model.

A confidentiality attack can comprise a membership inference attack that aims to determine whether certain training data have been used during training by a training client. Alternatively or additionally, a confidentiality attack can comprise an attribute inference attack that aims to derive meta-characteristics from training data of other training clients. Alternatively or additionally, a confidentiality attack can comprise a reconstruction attack that aims to reconstruct training data and/or associated labels that were used during training.

Thanks to the methods of the present invention disclosed herein, such confidentiality attacks on machine learning model updates can at least be made more difficult or prevented altogether. In addition to confidentiality, security can also be improved thanks to the methods of the present disclosure. In particular, the methods protect training clients from confidentiality attacks originating from a malicious aggregator and/or a malicious orchestrator, wherein the orchestrator is designed to coordinate federated learning.

Moreover, the methods of the present invention protect the confidentiality of the (trained) machine learning model from the training clients that wish to contribute local machine learning model updates. The methods of the present invention are therefore particularly suitable if the machine learning model is of great value or needs to be protected for other reasons.

In principle, in order to increase the security of the machine learning model, the entire training by the training clients could be implemented using multi-party computation (MPC).

However, this would have major disadvantages: First, the advantage of local training data for the training clients would no longer exist, since the originally local training data would have to be sent to an MPC system. Second, MPC training would cause excessive computational effort and excessively high costs. Instead, the methods of the present invention implement a different approach that avoids these disadvantages but still protects the machine learning model from the training clients.

According to an example embodiment of the present invention, training clients must authenticate themselves through a combination of zero-knowledge proofs and remote attestation in order to be allowed to contribute to the federated learning. On the other hand, this allows for the exclusion of non-authenticated training clients from the federated learning. The aggregator verifies that, during the secure aggregation, only those machine learning model updates are accepted whose training clients can prove knowledge of a (first) secret of the owner of the machine learning model. By using zero-knowledge proofs to protect the (first) secret from a malicious orchestrator, it can be prevented that this malicious orchestrator slips machine learning model updates into the secure aggregation that originate from non-authenticated training clients. Moreover, the training clients can be executed in a confidential-computing enclave (e.g., via Gramine). As a result, the machine learning model can be protected from unauthorized access by operators of the training clients.

### BRIEF DESCRIPTION OF THE DRAWINGS

FIG. 1A schematically illustrates a computer-implemented method for a federated learning process for an owner of a machine learning model, according to an example embodiment of the present invention.

FIG. 1B schematically illustrates a computer-implemented method for a federated learning process for an orchestrator, according to an example embodiment of the present invention.

FIG. 1C schematically illustrates a computer-implemented method for a federated learning process for a training client, according to an example embodiment of the present invention.

FIG. 1D schematically illustrates a computer-implemented method for a federated learning process for an aggregator, according to an example embodiment of the present invention.

FIG. 2 schematically illustrates a method comprising at least one method shown in FIGS. 1A-1D.

FIG. 3 schematically illustrates an owner of a machine learning model, an orchestrator, a training client, an aggregator and, optionally, a tester, according to an example embodiment of the present invention.

### DETAILED DESCRIPTION OF EXAMPLE EMBODIMENTS

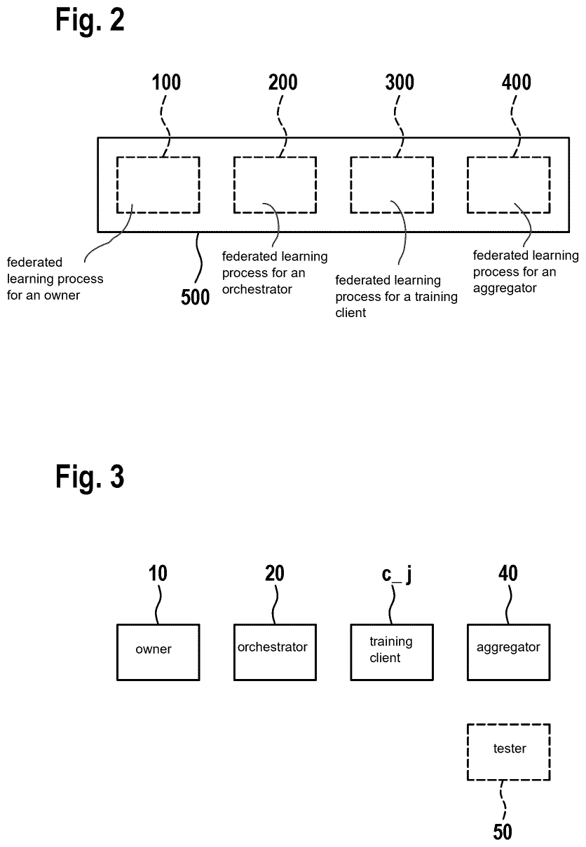

The computer-implemented methods described in the present disclosure are executed through the interaction of the following entities, see FIG. 3: an owner of a machine learning model, a plurality (usually a large number) of training clients, an orchestrator and an aggregator. Moreover, a tester can also be used.

The owner of the (global) machine learning model has the rights to the (global) machine learning model, both in its initial and trained states. In particular, the owner can choose the machine learning model, i.e., its architecture (e.g., number of neurons, layers, neurons per layer, etc.). The owner is also the recipient of the machine learning model trained in a federated manner. In the methods of the present disclosure, the owner can be the only one with plaintext access to the (trained) machine learning model.

A training client c_j of the plurality/large number C (i.e., j=1 to m) of training clients has (local) training data that at least should not be shared with third parties or that must not be shared with third parties. A training client can be a device (e. g., a computer) within an organizational unit (e.g., a clinic) that has (local) training data.

The orchestrator 20 coordinates federated learning by triggering actions on the training clients c_j. The coordination comprises, e.g., selecting training clients to be used in the next training iteration, providing references to the initial and updated (i.e., trained) machine learning model, and/or evaluating the training progress in a training iteration. Furthermore, the orchestrator delegates the aggregation 40 of the machine learning model updates of the training clients to the aggregator. Since communication is via identifiers, the orchestrator never sees the machine learning model updates or the machine learning model itself.

The aggregator 40 comprises a (secure) multi-party computation (MPC) cluster, i.e., in particular, a large number of devices (e.g., computers) that are designed for operations in the context of MPC. This means that every cluster member of the MPC cluster participates in the joint calculations of the cluster.

The input of each individual cluster member comprises a secret share in a secret share of the total input so that no single member learns the content of the total input, the content of its own secret share or the content of the shares of the other cluster members. The aggregator (i.e., the MPC cluster) receives the machine learning model updates from the training clients, calculates the aggregated model update and updates the global machine learning model accordingly. By using (secure) multi party computation (MPC), the aggregator advantageously has no knowledge of the model updates and the global machine learning model.

The following conventions are used below:

G_i denotes a machine learning model, more precisely an i-th version of the machine learning model (e.g., i=0 to n−1). G_0 can, for example, be an initial machine learning model for performing the disclosed methods. G_0 can, for example, be an untrained machine learning model. Alternatively, G_0 can be a machine learning model that has already been trained using the disclosed methods or otherwise. G_i can, for example, be a data structure of the model parameters that define the machine learning model.

CS(x) for, e.g., x=G_i or L_i_j denotes a multi-party computation (MPC) representation of x. Such a representation is invertible, i.e., x can be converted into the MPC representation CS(x) according to a predetermined MPC protocol, and the MPC representation CS(x) can also be converted into x according to the same predetermined MPC protocol. CS(x) can, for example, be an MP-SPDZ/Carbyne Stack representation.

ID(y) is an identifier of a secret share y, which is stored on the MPC cluster of the aggregator. In the case of Carbyne Stack, Amphora services of cluster members can be used, e.g., for this purpose.

L_i_j denotes a machine learning model update generated (locally) by a training client c_j in an i-th training iteration (e.g., i=0 to n−1). A machine learning model update can, for example, be a machine learning model updated through training.

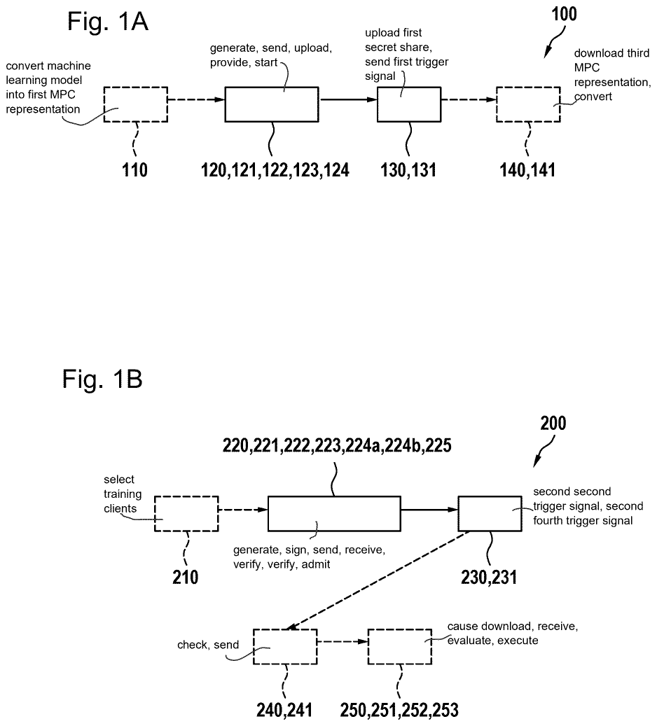

First, a computer-implemented method 100 for a federated learning process for an owner 10 of a machine learning model is disclosed, schematically represented in FIG. 1A.

The method 100 comprises generating 120 a first secret s and a first signature sig(s) on the basis of a Schnorr non-interactive zero-knowledge proof (Schnorr NIZKP).

Furthermore, the method 100 comprises sending 121 the first signature sig(s) to an orchestrator 20.

Furthermore, the method 100 comprises uploading 122 a fourth secret share of the first secret s to a cluster of the aggregator 40, wherein a reference identifier s_ref for the first secret s on the cluster of the aggregator 40 is obtained. Via the reference identifier, the first secret s stored on the cluster of the aggregator 40 can be accessed, in particular by a provided 123 secure aggregation function.

Furthermore, the method 100 comprises providing 123 a secure aggregation function SecAgg(s_ref) on the aggregator 40, which function is parameterized by the reference identifier s_ref. The secure aggregation function SecAgg(s_ref) can be based, e.g., on the algorithm from SAFELearn, see above. By parameterizing the secure aggregation function SecAgg(s_ref) with the reference identifier, the aggregator can later check whether the training clients c_j are allowed to upload their local machine learning model update to the cluster of the aggregator 40 after successful local training. The latter is only permitted if a training client c_j successfully proves that it knows the first secret s, and that this therefore corresponds to the secret retrievable under the reference identifier s_ref (secret according to reference identifier s_ref). The secure aggregation function SecAgg(s_ref) can be a specially developed algorithm within a federated learning system, which algorithm is designed to combine machine learning model updates that were generated by different participants (training clients) in a way that preserves the confidentiality of each individual contribution.

The secure aggregation function uses a reference identifier s_ref, which points to a shared secret, in order to ensure that only authorized updates are included in the aggregation.

Furthermore, the method 100 comprises starting 124 a secret provisioning service (e.g., Gramine) that is designed to provide a network endpoint through which at least one training client c_j can retrieve the first secret s, subject to successful attestation. A successful retrieval of the first secret s by a training client c_j enables the training client c_j to demonstrate knowledge of the first secret s when uploading its local machine learning model update.

The method 100 further comprises uploading 130 a first secret share of a first multi-party computation (MPC) representation CS(G_i) of a (e.g., initial) machine learning model G_i (i.e., e.g., G_0) to the cluster of the aggregator 40, wherein the owner 10 is sent a first identifier ID(CS(G_i)) for the first MPC representation CS(G_i) of the machine learning model G_i on the cluster of the aggregator 40. The uploaded 130 machine learning model can be an initial, i.e., an untrained, machine learning model (e.g., G_0). Alternatively, the uploaded 130 machine learning model can be a machine learning model G_i that has already been at least partially trained.

The method 100 further comprises sending 131 a first trigger signal comprising the first identifier ID (CS(G_i)) to the orchestrator 20. The first trigger signal can, e.g., consist only of the first identifier ID (CS(G_i)). The first trigger signal can cause the orchestrator 20 to execute federated learning on the training client. One advantage of providing the machine learning model G_i as a secret share and otherwise only an identifier of it may be that the orchestrator 20 does not receive the machine learning model itself. As a result, the confidentiality of the machine learning model is better ensured. The method 100 can further comprise converting 110 the (e.g., initial) machine learning model G_i into the first MPC representation CS (G_i) according to a predetermined MPC protocol.

The method 100 can further comprise downloading 140 a third MPC representation CS(G_(i+1)) of an aggregated machine learning model G_(i+1) from the cluster of the aggregator 40 on the basis of a third identifier ID (CS(G_(i+1))) for the third MPC representation CS(G_(i+1)) of the aggregated machine learning model G_(i+1) on the cluster of the aggregator 40 if the third identifier ID(CS(G_(i+1))) has been received. The method 100 can then further comprise converting 141 the third MPC representation CS(G_(i+1)) of the aggregated machine learning model G_(i+1) into a global machine learning model according to the predetermined MPC protocol. Due to the steps 140 and 141, the owner of the machine learning model can retrieve the machine learning model in a trained state. In the case of, e.g., n training iterations, CS(G_(n−1)) can also only be downloaded as the third MPC representation.

Furthermore, a computer-implemented method 200 for a federated learning process for an orchestrator 20 is disclosed, schematically illustrated in FIG. 1B.

The method 200 comprises generating 220 a second secret S and a second signature sig(S) on the basis of a Schnorr non-interactive zero-knowledge proof (Schnorr NIZKP).

Furthermore, the method 200 comprises, for each training client c_j of a plurality C of training clients c_j (j=1 to m) for a training iteration, signing 221 a random, training client-specific token t_j with the second secret S on the basis of Schnorr NIZKP, wherein (in each case) a signed token t_j_S is obtained.

Furthermore, the method 200 comprises then, for each training client c_j, sending 222 the signed token t_j_S as a challenge to the particular training client c_j.

Furthermore, the method 200 comprises, for each training client c_j, receiving 223 a proof p_j from the particular training client c_j.

Furthermore, the method 200 then comprises, for each training client c_j, verifying 224a the signed token t_j_S, encoded in the proof p_j, on the basis of the second signature sig(S), and, if successfully verified, verifying 224b the proof p_j on the basis of the first signature sig(s).

Furthermore, the method 200 then comprises admitting 225 those training clients c_j whose proof p_j has been successfully verified.

Thus, the steps 221 to 225 represent an authentication of training clients c_j before they are allowed to contribute to the federated learning. As a result, training clients c_j that could not be admitted can be blocked. As a result, a potentially harmful influence on the trained machine learning model (e.g., through intentionally false training data from a training client that was inserted into the federated learning by a malicious orchestrator) can be prevented.

The method 200 further comprises sending 230 a second trigger signal comprising a first identifier ID (CS(G_i)) for a first MPC representation CS (G_i) of a machine learning model G_i on a cluster of an aggregator 40 to each admitted 225 training client c_j of the plurality C (usually even a large number) of training clients c_j for the training iteration if a first trigger signal comprising the first identifier (ID(CS(G_i))) has been received. The second trigger signal can in each case cause an authorized 225 training client c_j to execute a training iteration. The second trigger signal can, e.g., consist only of the first identifier ID(CS(G_i)). In general, both the orchestrator and every training client c_j only know the first identifier ID(CS(G_i)) but not the machine learning model G_i (or its MPC representation CS (G_i)). The latter is stored in a trustworthy manner as a secret share on the cluster of the aggregator 40.

The method 200 can comprise selecting 210 the plurality/large number C of the training clients c_j for the training iteration according to a predetermined selection strategy.

Furthermore, the method 200 comprises sending 231 a fourth trigger signal comprising a second identifier ID(s_j) for a chained expression s_j=(s, CS(L_i_j)) comprising a first secret s and a second MPC representation CS(L_i_j) of a local machine learning model update L_i_j on the cluster of the aggregator 40 to the aggregator 40 if at least a third trigger signal comprising the second identifier ID(s_j) for the chained expression on the cluster of the aggregator 40 has been received. The third trigger signal can, e.g., consist only of the second identifier ID(s_j). Similarly, the fourth trigger signal can consist, e.g., only of the second identifier ID(s_j). One advantage is that only an admitted 225 training client is capable of forming the chained expression s_j that comprises the (correct) first secret s. By means of the chained expression s_j, it can later be checked whether the machine learning model update generated by the training client is allowed to contribute to the secure aggregation 431.

The fourth trigger signal can be sent 231 if a further third trigger signal comprising a further second identifier ID(s_j) for a further chained expression s_j=(s, CS(L_i_j)) comprising a further first secret s (in terms of content, it should be the same as the first secret s for admission) and a further second MPC representation CS(L_i_j) of a further local machine learning model update L_i_j on the cluster of the aggregator 40 has been received from at least one further training client c_j (for another j) of the plurality/large number C of training clients c_j for the training iteration, wherein the fourth trigger signal comprises the further second identifier ID(s_j).

The fourth trigger signal can be sent 231 in particular if a respective third trigger signal comprising a respective second identifier ID(s_j) for a respective further chained expression s_j=(s, CS(L_i_j)) comprising a respective first secret s and a respective second MPC representation CS(L_i_j) of a respective local machine learning model update L_i_j on the cluster of the aggregator 40 has been received from each training client c_j of the plurality/large number C of training clients c_j for the training iteration, wherein the fourth trigger signal comprises every second identifier ID(s_j) (j=1 to m).

The method 200 can further comprise checking 240, if a third identifier ID(CS(G_(i+1))) for a third MPC representation CS(G_(i+1)) of an aggregated machine learning model G_(i+1) on the cluster of the aggregator 40 has been received, whether a further training iteration for the aggregated machine learning model G_(i+1) is to be performed.

The method 200 can then further comprise sending 241 the third identifier ID(CS(G_(i+1))) to an owner 10 of the machine learning model if no further training iteration is to be performed. Otherwise, the methods can be repeated for each further training iteration (e.g., n training iterations), wherein, e.g., ID(CS(G_(n−1))) is returned as the third identifier to the owner 10 of the machine learning model.

The methods 100, 200, 300, 400, 500 already protect the machine learning model against malicious training clients. Furthermore, they protect the machine learning model from being disclosed to the orchestrator 20. However, there is still a potential risk that the orchestrator 20 could negatively affect the quality of the (trained) machine learning model through a maliciously biased selection of training clients. This can be prevented as follows:

The method 200 can be executed within a Trusted Execution Environment (TEE). This increases security, in particular by preventing the orchestrator 20 from maliciously deviating from the method 200 and/or the intended manner. Here, the owner 10 of the machine learning model can, e.g., by means of remote attestation, trust that the orchestrator 20 adheres to the predetermined selection strategy. This prevents a maliciously biased selection of training clients.

Furthermore, in the method 200, logging can be executed in a trustworthy manner on an external memory, optionally on a distributed ledger. This can also increase security since processes can be traced even afterwards. Trustworthy logging can be achieved, for example, by encrypting log entries in an asymmetric manner using a public key of the owner 10 of the machine learning model. Alternatively, the log entries can be encrypted with a private symmetric key that the orchestrator 20 and owner 10 of the machine learning model have agreed upon in advance.

Furthermore, in the method 200, the orchestrator 20 can cause 250 at least one training client c_j to download the aggregated machine learning model G_(i+1) and to evaluate the quality of the aggregated machine learning model G_(i+1) on the basis of local test data of the training client (according to a predetermined local test criterion), wherein at least one second test result that is sent to the orchestrator 20 is obtained.

The method 200 can then comprise receiving 251 at least the second test result.

The method 200 can then evaluate 252 the at least second test result along with a first test result that is obtained from a tester 50 that is designed to evaluate the quality of the aggregated machine learning model G_(i+1) on the basis of local test data of the tester 50 (also according to a predetermined test criterion), wherein the evaluation is based on MPC or homomorphic encryption, wherein an evaluation result is obtained.

The method 200 can then comprise executing 253 one or more predetermined actions depending on the evaluation result. A predetermined action can, e.g., consist of omitting further training iterations, because the evaluation result is already satisfactory. Alternatively, a predetermined action can also consist of, e.g., switching to a different predetermined selection strategy of the training clients.

Furthermore, a computer-implemented method 300 for a federated learning process for a training client c_j is disclosed, schematically represented in FIG. 1C.

The method 300 comprises retrieving 310 a first secret s from a network endpoint of a secret provisioning service (e.g., Gramine) of an owner 10 of a machine learning model if an attestation of the training client is successful. If, e.g., remote attestation fails, the first secret cannot be retrieved. In this case, e.g., it makes no sense for the training client to be started, since the resulting machine learning model update would later not be accepted during the secure aggregation 431.

If an unprotected training client is nevertheless started, it may still be able to connect to the orchestrator 20 under certain circumstances. However, it would never be selected by an honest orchestrator 20 for a training iteration.

The method 300 further comprises receiving 311 a signed token t_j_S as a challenge from an orchestrator 20.

The method 300 further comprises, if the first secret s could be retrieved, signing 312 the signed token t_j_S with the first secret s, wherein a proof (p_j=sign (s, t_j_S) is obtained.

The method 300 further comprises sending 313 the proof p_j to the orchestrator 20.

The method 300 further comprises, if the training client c_j has been admitted 225 by the orchestrator 20, downloading 320 a first MPC representation CS (G_i) of a machine learning model G_i from a cluster of an aggregator 40 on the basis of a first identifier ID(CS(G_i)) if a second trigger signal comprising the first identifier ID(CS(G_i)) has been received and the identity and authorization of the training client c_j on the cluster of the aggregator 40 have been verified. Verifying the identity and authorization of the training client can, e.g., be based on a predetermined protocol for authentication and/or authorization.

The method 300 then comprises converting 321 the first MPC representation CS(G_i) of the machine learning model into a local machine learning model according to a predetermined MPC protocol (the same MPC protocol as in the method 100). The local machine learning model can be, e.g., the machine learning model G_i and, in particular, the initial machine learning model G_0. Alternatively, the local machine learning model can be a further representation of the machine learning model G_i (in particular of G_0), which representation is designed for training on the training client c_j.

The method 300 further comprises training 330 the local machine learning model on the basis of local training data of the training client, wherein a local machine learning model update L_i_j is generated. The local machine learning model update L_i_j can, e.g., be the trained local machine learning model.

The method 300 further comprises converting 340 the local machine learning model update L_i_j into a second MPC representation CS(L_i_j) according to the predetermined MPC protocol.

The method 300 further comprises generating 341 a chained expression s_j=(s, CS(L_i_j)) comprising the first secret s and the second MPC representation CS(L_i_j).

The method 300 then further comprises uploading 342 a second secret share of the chained expression s_j to the cluster of the aggregator 40, wherein a second identifier ID(s_j) for the chained expression s_j on the cluster of the aggregator 40 is sent to the training client c_j. By providing the first secret s in the chained expression s_j, the secure aggregation function SecAgg(s_ref) provided 123 to the aggregator 40 can verify that the particular training client c_j actually has knowledge of the first secret s. As a result, it is ensured that only admitted 225 training clients c_j are allowed to contribute machine learning model updates L_i_j during aggregation.

The method further comprises sending 343 a third trigger signal comprising the second identifier ID(s_j) to the orchestrator 20. The method 300 can be executed (on at least one training client c_j or on each training client c_j of the plurality C) within a Trusted Execution Environment (TEE). As a result, it is ensured that one or more training clients c_j, preferably all training clients, cannot (maliciously) deviate from the method 300. As a result, e.g., misuse of the machine learning model can be prevented.

Furthermore, a computer-implemented method 400 for a federated learning process for an aggregator 40 is disclosed, schematically illustrated in FIG. 1D.

The method 400 comprises sending 410 a first identifier ID(CS(G_i)) for a first MPC representation CS(G_i) of a machine learning model G_i on a cluster of the aggregator 40 to an owner 10 of the machine learning model G_i if a first secret share of the first MPC representation CS(G_i) is uploaded to the cluster of the aggregator 40.

The method 400 further comprises sending 420 a second identifier ID(s_j) for a chained expression s_j=(s, CS(L_i_j)) comprising a first secret s and a second MPC representation CS(L_i_j) of a local machine learning model update L_i_j on the cluster of the aggregator 40 to a training client c_j if a second secret share of the chained expression s_j=(s, CS(L_i_j)) is uploaded to the cluster of the aggregator 40.

The method 400 further comprises, if a fourth trigger signal comprising a second identifier ID(s_j) for a chained expression s_j=(s, CS(L_i_j)) comprising a first secret s and a second MPC representation CS(L_i_j) of a local machine learning model update L_i_j on the cluster of the aggregator 40 is received, executing 430 a secure aggregation function SecAgg(s_ref) provided 123 by the owner 10 of the machine learning model G_i, which function is parameterized by a reference identifier s_ref, wherein, during execution, it is checked whether the chained expression s_j=(s, CS(L_i_j)) comprises the secret according to the reference identifier s_ref.

The method 400 further comprises, if the chained expression s_j=(s, CS(L_i_j)) comprises the secret according to the reference identifier s_ref, securely aggregating 431 a local machine learning model update L_i_j with at least one further local machine learning model update on the basis of a predetermined MPC circuit, wherein a third secret share of a third MPC representation CS(G_(i+1)) for an aggregated machine learning model G_(i+1) on a cluster of the aggregator 40 along with a third identifier ID(CS(G_(i+1))) for the third MPC representation CS(G_(i+1)) is obtained. Secure aggregation 431 can be implemented, e.g., by or on the basis of the algorithm from SAFELearn, see above. The aggregated machine learning model G_(i+1) can, e.g., be based on a weighting of local machine learning model updates L_i_j (for different_j). By checking whether the chained expression s_j=(s, CS(L_i_j)) comprises the secret according to the reference identifier s_ref, it can be prevented that machine learning model updates from training clients that are not admitted 225 are taken into account in the secure aggregation 431.

The method 400 then comprises sending 432 the third identifier ID(CS(G_(i+1))) to an orchestrator 20.

Alternatively, after n training iterations, an aggregated machine learning model CS(G_(n−1)) can be aggregated and a corresponding identifier ID(CS(G_(n−1))) can be sent 432 to the orchestrator 20.

The method 400 can further comprise sending 440 the third identifier ID(CS(G_(i+1))) for the third MPC representation CS(G_(i+1)) to a tester 50, which is designed to download the aggregated machine learning model G_(i+1) and to evaluate the quality of the aggregated machine learning model G_(i+1) on the basis of local test data of the tester 50 (e.g., according to a predetermined test criterion), wherein the evaluation is based on MPC or homomorphic encryption, wherein a first test result that is sent to the aggregator 40 is obtained.

The method 400 can then comprise receiving 441 the first test result.

The method 400 can then comprise sending 442 the first test result to the orchestrator 20. Depending on the first test result, one or more predetermined actions can be executed by the orchestrator 20 in the method 200, see above.

Alternatively, the machine learning model CS(G_(n−1)) aggregated after n training iterations can be used as the basis for evaluation.

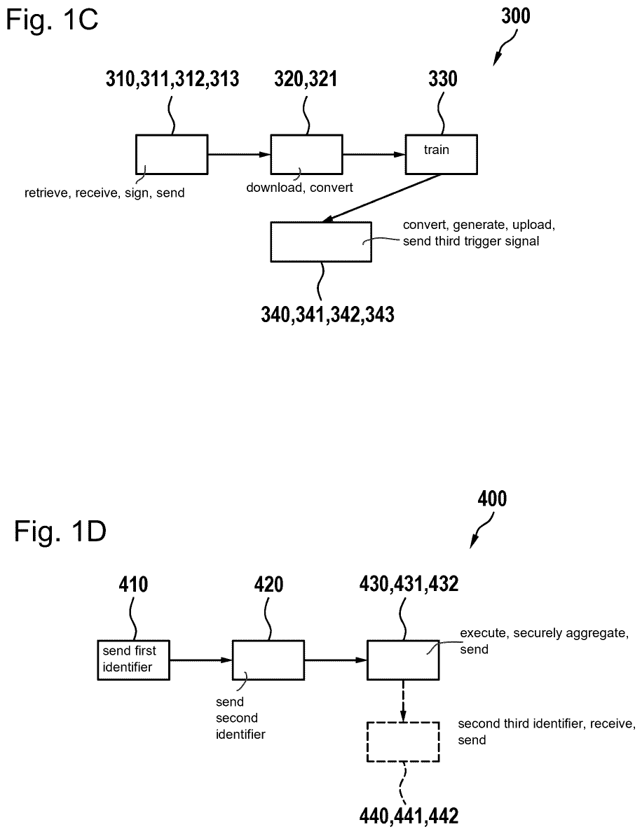

Furthermore, one or more combined methods 500 are disclosed, schematically illustrated in FIG. 2.

A method 500 can comprise the computer-implemented method 100 for a federated learning process for an owner 10 of a machine learning model. Alternatively or additionally, the method 500 can comprise the computer-implemented method 200 for a federated learning process for an orchestrator 20. Alternatively or additionally, the method 500 can comprise the computer-implemented method 300 for a federated learning process for a training client c_j. Alternatively or additionally, the method 500 can comprise the computer-implemented method 400 for a federated learning process for an aggregator 40.

The predetermined MPC protocol in the methods 100, 200, 300, 400, 500 can be based on fixed-point numbers, floating-point numbers and/or integers (e.g., int8 quantization). The choice can be made depending on the desired compromise between the performance and accuracy of the machine learning model. While a variant based on fixed-point numbers is faster but may cause quantization errors, a variant based on floating-point numbers requires more computing power and also consumes more bandwidth (in the network) but makes a more accurate mapping possible between the original and the MPC-compatible representation of the machine learning model.

Alternatively, the methods 100, 200, 300, 400, 500 can be adapted in such a way that the orchestrator 20 has access to the global machine learning model. In this variant, only the secure aggregation of the local machine learning model updates is carried out by the aggregator 40 via MPC. Here, the exchange of the global machine learning model with the training clients is carried out in-band, i.e., via regular communication channels.

Furthermore, one or more devices are disclosed, which in each case are designed to execute one or more methods 100, 200, 300, 400, 500. Each of these devices comprises at least one computing unit (at least one processor) and one working memory (e.g., RAM) and can also comprise a non-volatile memory. For example, a device can comprise a computing unit for the owner 10 of the machine learning model. A further device can, for example, comprise a computing unit for the orchestrator 20. One or more further devices can, for example, in each case comprise at least one computing unit for a training client c_j. A further device can, for example, comprise at least one computing unit (usually a large number of computing units for the cluster) for the aggregator 40. A device can further comprise computing units for the owner 10 of the machine learning model, for the orchestrator 20, for each training client c_j and/or for the aggregator 40.

Such a device can, e.g., link the computing units in a network. Furthermore, one or more computer programs are disclosed, which in each case are designed to execute one or more methods 100, 200, 300, 400, 500. Each of these computer programs can be present, e.g., in interpretable or in compiled form. For execution, it can be loaded (even in portions) into the working memory (e.g., RAM) of a device, e.g., as a bit or byte sequence. Furthermore, one or more data carriers or signals are disclosed, which in each case contain or encode a disclosed computer program. The data carrier can comprise, e.g., any one of RAM, ROM, EPROM, HDD, SDD, on/in which the signal is stored. A data carrier on which a computer program comprising the methods 100, 200, 300, 400, 500 is stored can be a non-volatile memory of a device.

1-21. (canceled)

22. A computer-implemented method for a federated learning process for an owner of a machine learning model, comprising the following steps:
generating a first secret and a first signature based on a Schnorr non-interactive zero-knowledge proof;
sending the first signature to an orchestrator;
uploading a fourth secret share of the first secret to a cluster of an aggregator, wherein a reference identifier for the first secret on the cluster of the aggregator is obtained;
providing a secure aggregation function on the aggregator, the function being parameterized by the reference identifier;
starting a secret provisioning service that is configured to provide a network endpoint through which at least one training client can retrieve the first secret, subject to successful attestation;
uploading a first secret share of a first multi-party computation (MPC) representation of a machine learning model to the cluster of the aggregator, wherein the owner is sent a first identifier for the first MPC representation of the machine learning model on the cluster of the aggregator; and
sending a first trigger signal including the first identifier to the orchestrator.

23. The method according to claim 22, further comprising:
converting the machine learning model into the first MPC representation according to a predetermined MPC protocol.

24. The method according to claim 22, further comprising:
downloading a third MPC representation of an aggregated machine learning model from the cluster of the aggregator based on a third identifier for the third MPC representation of the aggregated machine learning model on the cluster of the aggregator when the third identifier has been received; and
converting the third MPC representation of the aggregated machine learning model into a global machine learning model according to the predetermined MPC protocol.

25. A computer-implemented method for a federated learning process for an orchestrator, comprising the following steps:
generating a second secret and a second signature based on a Schnorr non-interactive zero-knowledge proof (Schnorr NIZKP);
for each training client of a plurality of training clients for a training iteration, signing a random, training client-specific token with the second secret based on the Schnorr NIZKP to obtain a signed token;
for each training client of the plurality of training clients, sending the signed token as a challenge to the training client;
for each training client of the plurality of training clients, receiving a proof from the training client;
for each training client of the plurality of training clients, verifying the signed token, encoded in the proof, based on the second signature, and, based on successfully verifying, verifying the proof based on the first signature;
admitting those of the plurality of training clients whose proof has been successfully verified;
sending a second trigger signal including a first identifier for a first multi-party computation (MPC) representation of a machine learning model on a cluster of an aggregator to each of the admitted training clients of the plurality of training clients for the training iteration when a first trigger signal including the first identifier has been received; and
sending a fourth trigger signal including a second identifier for a chained expression including a first secret and a second MPC representation of a local machine learning model update on the cluster of the aggregator to the aggregator when at least a third trigger signal including the second identifier for the chained expression on the cluster of the aggregator has been received.

26. The method according to claim 25, comprising:
selecting the plurality of the training clients for the training iteration according to a predetermined selection strategy.

27. The method according to claim 25, wherein:
the fourth trigger signal is sent when a further third trigger signal including a further second identifier for a further chained expression including a further first secret and a further second MPC representation of a further local machine learning model update on the cluster of the aggregator has been received from at least one further training client of the plurality of the training clients for the training iteration; and
the fourth trigger signal includes the further second identifier.

28. The method according to claim 25, wherein:
the fourth trigger signal is sent when a respective third trigger signal including a respective second identifier for a respective further chained expression including a respective first secret and a respective second MPC representation of a respective local machine learning model update on the cluster of the aggregator has been received from each training client of the plurality of the training clients for the training iteration; and
the fourth trigger signal includes every respective second identifier.

29. The method according to claim 25, further comprising:
checking, when a third identifier for a third MPC representation of an aggregated machine learning model on the cluster of the aggregator has been received, whether a further training iteration for the aggregated machine learning model is to be performed;
sending the third identifier to an owner of the machine learning model when no further training iteration is to be performed.

30. The method according to claim 25, wherein the method is executed within a Trusted Execution Environment.

31. The method according to claim 25, wherein logging is executed in a trustworthy manner on an external memory, on a distributed ledger.

32. The method according to claim 25, wherein:
the orchestrator causes at least one training client of the plurality of training clients to download the aggregated machine learning model and to evaluate the quality of the aggregated machine learning model based on local test data of the at least one training client;
at least one second test result that is sent to the orchestrator is obtained; and
the method further comprises:
receiving the at least second test result;
evaluating the at least second test result along with a first test result that is obtained from a tester that is configured to evaluate a quality of the aggregated machine learning model based on local test data of the tester,
wherein the evaluation is based on MPC or homomorphic encryption, to obtain an evaluation result; and
executing a predetermined action depending on the evaluation result.

33. A computer-implemented method for a federated learning process for a training client, comprising the following steps:
retrieving a first secret from a network endpoint of a secret provisioning service of an owner of a machine learning model when an attestation of the training client is successful;
receiving a signed token as a challenge from an orchestrator;
when the first secret is retrieved, signing the signed token with the first secret to obtain a proof;
sending the proof to the orchestrator;
when the training client has been admitted by the orchestrator, downloading a first multi-party computation (MPC) representation of a machine learning model from a cluster of an aggregator based on a first identifier when a second trigger signal including the first identifier has been received and the identity and authorization of the training client on the cluster of the aggregator have been verified;
converting the first MPC representation of the machine learning model into a local machine learning model according to a predetermined MPC protocol;
training the local machine learning model based on local training data of the training client to generate a local machine learning model update;
converting the local machine learning model update into a second MPC representation according to the predetermined MPC protocol;
generating a chained expression including the first secret and the second MPC representation;
uploading a second secret share of the chained expression to the cluster of the aggregator, wherein a second identifier for the chained expression on the cluster of the aggregator is sent to the training client; and
sending a third trigger signal comprising the second identifier to the orchestrator.

34. The method according to claim 33, wherein the method is executed within a Trusted Execution Environment (TEE).

35. A computer-implemented method for a federated learning process for an aggregator, comprising the following steps:
sending a first identifier for a first multi-party computation (MPC) representation of a machine learning model on a cluster of the aggregator to an owner of the machine learning model when a first secret share of the first MPC representation is uploaded to the cluster of the aggregator;
sending a second identifier for a chained expression including a first secret and a second MPC representation of a local machine learning model update on the cluster of the aggregator to a training client when a second secret share of the chained expression is uploaded to the cluster of the aggregator;
when a fourth trigger signal including a second identifier for a chained expression including a first secret and a second MPC representation of a local machine learning model update on the cluster of the aggregator is received, executing a secure aggregation function provided by the owner of the machine learning model, the secure aggregation function being parameterized by a reference identifier, wherein, during execution, it is checked whether the chained expression includes the secret according to the reference identifier;
when the chained expression includes the secret according to the reference identifier, securely aggregating a local machine learning model update with at least one further local machine learning model update based on a predetermined MPC circuit, wherein a third secret share of a third MPC representation for an aggregated machine learning model on a cluster of the aggregator along with a third identifier for the third MPC representation is obtained; and
sending the third identifier to an orchestrator.

36. The method according to claim 35, wherein the aggregated machine learning model is based on a weighting of local machine learning model updates.

37. The method according to claim 35, further comprising:
sending the third identifier for the third MPC representation to a tester, which is configured to download the aggregated machine learning model and to evaluate a quality of the aggregated machine learning model based on local test data of the tester, wherein the evaluation is based on MPC or homomorphic encryption, wherein a first test result that is sent to the aggregator is obtained;
receiving the first test result; and
sending the first test result to the orchestrator.

38. The method according to claim 33, wherein the predetermined MPC protocol is based on fixed-point numbers and/or floating-point numbers and/or integers.

39. A device configured to implement method for a federated learning process for an owner of a machine learning model, the method comprising the following steps:
generating a first secret and a first signature based on a Schnorr non-interactive zero-knowledge proof;
sending the first signature to an orchestrator;
uploading a fourth secret share of the first secret to a cluster of an aggregator, wherein a reference identifier for the first secret on the cluster of the aggregator is obtained;
providing a secure aggregation function on the aggregator, the function being parameterized by the reference identifier;
starting a secret provisioning service that is configured to provide a network endpoint through which at least one training client can retrieve the first secret, subject to successful attestation;
uploading a first secret share of a first multi-party computation (MPC) representation of a machine learning model to the cluster of the aggregator, wherein the owner is sent a first identifier for the first MPC representation of the machine learning model on the cluster of the aggregator; and
sending a first trigger signal including the first identifier to the orchestrator.

40. A computer-readable storage medium on which is stored a computer program implemented method for a federated learning process for an owner of a machine learning model, the computer program, when executed by a computer, causing the computer to perform the following steps comprising:
generating a first secret and a first signature based on a Schnorr non-interactive zero-knowledge proof;
sending the first signature to an orchestrator;
uploading a fourth secret share of the first secret to a cluster of an aggregator, wherein a reference identifier for the first secret on the cluster of the aggregator is obtained;
providing a secure aggregation function on the aggregator, the function being parameterized by the reference identifier;
starting a secret provisioning service that is configured to provide a network endpoint through which at least one training client can retrieve the first secret, subject to successful attestation;
uploading a first secret share of a first multi-party computation (MPC) representation of a machine learning model to the cluster of the aggregator, wherein the owner is sent a first identifier for the first MPC representation of the machine learning model on the cluster of the aggregator; and
sending a first trigger signal including the first identifier to the orchestrator.
